(19) United States
(12) Patent Application Publication
(10) Pub. No.: US 2009/0081607 A1
(43) Pub. Date: Mar. 26, 2009

(54) DENTAL RINSING UNIT

(76) Inventor: Hans-Peter Frey, Frankenthal (DE)

Correspondence Address: FITZPATRICK CELLA HARPER & SCINTO, 30 ROCKEFELLER PLAZA, NEW YORK, NY, 10112, US

(21) Appl. No.: 12/280,437

(22) PCT Filed: Feb. 21, 2007
(86) PCT No.: PCT/EP2007/051635

§ 371 Date: Aug. 22, 2008

(30) Foreign Application Priority Data
Feb. 23, 2006 (DE) 10 2006 008 944.8

(51) Int. Cl. A61C 17/00; B08B 5/04

(52) U.S. Cl. 433/82; 134/21

(57) ABSTRACT

The invention relates to a cleaning container (12) comprising an inlet (120) which is connected to the water container (11), and an outlet for connecting a suction tube (43), the outlet (122) being embodied as a hydrant (124) for a suction handpiece (42) applied to the suction tube (43). The cleaning container (12) can be filled with the water from the water container (11) especially by means of a negative pressure applied to the outlet when the suction tube (43) is connected.

### TECHNICAL FIELD

The present invention relates to a dental rinsing unit comprising at least one water tank that can be connected to a water supply system, for example, and can be filled with water from a free inflow connector.

### PRIOR ART

DE 195 10 462 A1 describes a suction system. It is used in combination with a rinsing unit of the generic kind. The rinsing unit comprises a cuspidor to which water is supplied from a water tank, which is not further described. Moreover, a storage vessel connected to the cuspidor is provided for intermediate storage of the waste water. The waste water is sucked off by means of the suction system, which is connected to the rinsing unit by pipes laid in the floor. Solid particles present in the waste water tend to deposit on the inside wall of the pipes thus making it very necessary to clean the pipes at regular intervals.

Suction systems of this kind are usually cleaned by rinsing a suction hose of the suction system with a large quantity of water. For this purpose, the end of the suction hose is immersed in a vessel full of water so that a relatively large quantity of water is drawn through the suction hose. This causes partial entrainment of the particles deposited on the inside wall of the suction hose and the suction hose is cleaned.

DE 71 21 112 U discloses a device for disinfecting the suction hose of dental suction systems, in which device a free end of the suction hose can be directly connected to the container for the disinfectant. When the hose is plugged in, an electric switch activates spraying, on the one hand, and suction, on the other.

It is an object of the present invention to configure and arrange a rinsing unit such that cleaning of the suction system can be carried out in an improved and timesaving manner.

### SUMMARY OF THE INVENTION

This object is achieved by the features of claim 1.

In the dental rinsing unit, a cleaning tank is provided, which comprises an inlet orifice, which communicates with the water tank, and additionally an outlet for connecting the cleaning tank to a suction hose, the outlet being designed as a tap for a suction handpiece mounted on the suction hose. The water tank is integrated in the rinsing unit for cleaning the suction system so that the tap can simultaneously be the depository for the suction hose and the rinsing operation can be initiated whenever the suction system is not in use, that is to say, between individual treatments, if necessary.

According to the invention, the cleaning tank comprises at least one first sub-container designed as a reservoir for holding the water and a second sub-container designed as a riser connected to the reservoir, with the open end of the riser remote from the reservoir forming the outlet. The cleaning tank is thus divided into two functionally separate units, each of which performs a different function. The reservoir holds the water and delimits its volume. The riser extending substantially vertically ensures that water cannot enter into the suction hose during the filling operation and that air cannot be sucked in via the valve and the outlet, not even when the water level in the reservoir is at its lowest.

Furthermore, a connection between the reservoir and the riser is provided below the vent hole and below the outlet. All the water present in the reservoir is thus available during the rinsing operation.

The cleaning tank can advantageously be filled with water from the water tank by means of a reduced pressure applied to the outlet when the suction hose is connected. This enables the cleaning tank to be filled automatically. It also eliminates the necessity of manually filling a separate cleaning tank. This also means that a separate pump or similar means, with the aid of which the cleaning tank could have been filled, is replaced by the suction system. The suction system, which must in any case be activated for cleaning purposes, at the same time serves as means for conveying water from the water tank to be used for the cleaning operation.

In this respect, it is also advantageous if the cleaning tank comprises a vent hole in addition to the inlet orifice and the cleaning tank can be filled with water from the water tank by means of a reduced pressure that can be generated at the outlet, and if at least one valve of a control unit is disposed on the vent hole, it being possible to open, close, and adjust said valve manually and/or automatically with the aid of a control system in the control unit in accordance with at least one physical parameter.

The valve serves to vent the filled cleaning tank and is closed during the filling operation. During and immediately after the process of filling the cleaning tank, a reduced pressure prevails in the cleaning tank due to suction. On account of the rapid venting of the cleaning tank, the water present in the cleaning tank is conveyed into the suction hose impulsively. The pulse thus generated is decisive for the quality of the cleaning operation. The greater the pulse, the larger the number of solid particles entrained. The magnitude of the pulse significantly depends on the volume of the water available in the cleaning tank during a rinsing operation.

According to a development of the invention, the control unit alternatively further comprises a control valve controlling the valve. This simplifies venting and makes it possible to achieve very fast closing speeds for the valve depending on the dimensions of the control valve. It is essential to the pulsed rinsing operation of the invention that the valve be in its closed position when the cleaning tank is being filled. Since the pulse is caused by rapid venting of the cleaning tank, the valve should have the maximum possible nominal width.

It is further advantageous if the control unit cooperates with at least one pressure sensor, by means of which a reduced pressure prevailing inside the water tank and/or the cleaning tank can be detected by the control system.

The rinsing operation is initiated when the cleaning tank has been filled. As long as the valve is open, a reduced pressure cannot be built up and thus water also cannot be sucked from the water tank. In its quiescent state, the valve is closed. When the suction hose is fitted on to the cleaning tank, a reduced pressure is created. The pressure sensor reacts to this reduced pressure and starts a timer. In addition, the filling operation of the cleaning tank begins. The valve opens after the expiration of a defined time interval measured by means of a timer in the control system. The time interval is long enough for the cleaning tank to fill up completely.

It is also advantageous if the control unit comprises at least one filling level indicator disposed on the cleaning tank and by the use of which at least one water level inside the cleaning tank can be detected by the control system. The cleaning tank is filled only as long as the suction hose engages the outlet to produce a reduced pressure in the cleaning tank. The valve should be in its closed position for the purpose of detecting the pressure present. Otherwise, the pressure difference on pulling the suction hose from the outlet would be too small for detection of the prevailing reduced pressure present. This prevents further filling of the cleaning tank should the suction hose be pulled off by mistake. The maximum permissible water level in the cleaning tank is reached when the filling level indicator is activated. At this point, opening of the valve is initiated. Pulsed rinsing does not take place before the cleaning tank is full, since it is only then that the volume of water required for an efficient cleaning operation is available. The cleaning cycle may be repeated a number of times in order to achieve a more thorough cleaning action. A feedback mechanism may be provided such that the valve is closed following pulsed rinsing and the cleaning tank is refilled.

The means for triggering the filling operation following pulsed rinsing may be the filling level indicator, when not detecting any water in the cleaning tank, or the control valve capable of closing the valve. The loop comprising repeated cleaning cycles can then be stopped, for example, by the removal of the suction hose or an interruption of the water supply for filling the cleaning tank.

Alternatively, the control unit is provided with at least one manually operable switch, by means of which the valve can be switched. By this means, filling will be restarted by a closure of the valve only when the switch has been activated. The valve is thus open in its quiescent state and is closed by activation of the switch. Water is sucked from the water tank after closure of the valve. Closing the valve thus does not automatically start the filling operation.

Pulsed rinsing can be intensified by connecting the output of the valve to the vent hole and connecting the input of the valve to the atmosphere or to a pressure tank. Using this overpressure method, compressed air is fed into the system when the valve is opened. This further increases the pressure gradient inside the cleaning tank toward its outlet and increases the suck-off speed and thus the pulse. Compressed air is preferably used with very long suction hoses and very long waste pipes.

Preferably, a sensor is then provided which is adapted to determine whether the suction hose is connected to the outlet of the cleaning tank and which immediately switches off the overpressure when the suction hose is prematurely removed. This prevents discharge of water from the open outlet when the suction hose is removed therefrom by mistake during the filling operation.

Advantageously, the cleaning tank is situated in relation to the water tank above the highest possible level of the water in the water tank. This ensures that the cleaning tank is filled only when the suction system is connected without it being necessary to provide additional valves in the line. If the cleaning tank and the line were at least partially situated below the top water level in the water tank, water would flow into the cleaning tank in the absence of additional safety measures.

In connection with the design and configuration provided by the invention, it is advantageous when a mixing unit is connected to the water tank such that a cleaning agent could be supplied in controlled doses to the water in the water tank with the aid of said mixing unit.

Alternatively, it is advantageous if the reservoir and the riser are designed as a U-shaped pipe or tubing or as a siphon. Such basic shapes provide all of the advantages described above.

The cleaning tank of the invention need not necessarily be filled by means of the suction system. Other methods of filling the cleaning tank are conceivable, for instance, pump filling.

One of the preferred solutions is a system consisting of a rinsing unit according to the invention and a dental suction system comprising at least one suction handpiece connected via a suction hose.

The suction system may comprise a plurality of suction hoses and the rinsing unit may comprise a plurality of cleaning tanks and/or a plurality of taps on one and the same cleaning tank.

The rinsing unit of the invention is based on a method by means of which cleaning of suction systems of this type can be carried out. With this method, the suction system is switched on, say, automatically when the suction hose is removed from its depository, the water tank being at least partially filled at all times, with water. The suction hose is connected to the outlet of the cleaning tank. In the case of manual control, the valve is closed after the switch has been activated and the filling operation is thus initiated. In the case of automatic control, the valve is already closed in its quiescent state and the filling operation starts as soon as the suction hose is connected. Water is sucked from the water tank into the cleaning tank through the suction hose by the suction system due to the reduced pressure generated in the cleaning tank. The quantity of water flowing into the cleaning tank is controlled by time measurement or by means of the filling level indicator inside the cleaning tank. After a defined quantity of water has flowed into the cleaning tank, the valve is opened and the volume of water present in the cleaning tank is sucked by the suction system and discharged, at least partially, impulsively from the cleaning tank.

It is advantageous, for this purpose, if the time measurement is started by means of a timer in the control system when the valve is closed. This is one of the simplest and relatively maintenance-free solutions.

It is of significant advantage if the valve is opened after the filling level indicator in the cleaning tank indicates the maximum water level. This makes it possible to utilize the maximum volume of the cleaning tank or reservoir, which in turn increases the pulse for the cleaning operation.

It is further advantageous if the valve is closed immediately after the rinsing operation or after a reduced pressure has been generated in the cleaning tank. This enables the filling operation for the cleaning tank to be initiated automatically whenever the suction hose is fitted onto the outlet.

Alternatively, the valve is closed by the manually operable switch of the control system before filling of the cleaning tank starts. As a result, the valve that is open in its quiescent state is closed by activation of the switch and the filling operation is initiated.

Intense cleaning of the suction hose and the other waste pipes is achieved by initiating at least one additional rinsing operation after the completion of a first rinsing operation and before the suction hose is removed from the outlet. As long as the suction hose is not in use and is fitted to the outlet or the tap, the option for performing the cleaning operation is given.

The cleaning effect can be further increased by conveying water from the cleaning tank into the suction hose with the aid of compressed air after the valve has been opened, in addition to the reduced pressure generated at the outlet, the compressed air being introduced through the valve. For this purpose, a sensor is preferably provided which determines whether the suction hose is connected and switches off the overpressure immediately when the suction hose is prematurely removed.

### BRIEF DESCRIPTION OF THE DRAWINGS

The device of the invention and the method of the invention will be explained below with reference to the drawings, in which:

FIG. 1 is a functional diagram of a system comprising a rinsing unit and a dental suction system including a pressure sensor,

FIG. 2 shows a rinsing unit as illustrated in FIG. 1 including a manual switch,

FIG. 3 shows a rinsing unit as illustrated in FIG. 1 including a filling level indicator,

FIG. 4 shows a cutaway section of a cleaning tank comprising a reservoir and a riser.

### EXEMPLARY EMBODIMENTS OF THE INVENTION

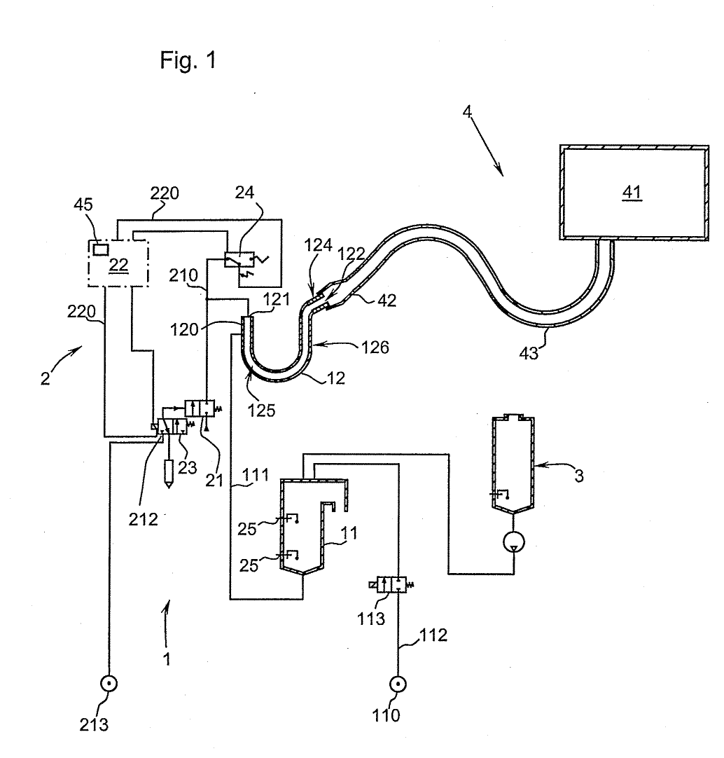

The reference numeral 1 in FIG. 1 indicates a rinsing unit intended primarily for use by dentists and comprising a water tank 11. The water tank 11 comprises a free inflow connecter and is connected to a conventional water supply 110 through a supply conduit 112.

Inside the water tank 11, upper and lower filling level indicators 25 are provided for monitoring the water level. As soon as the level of water in the water tank 11 falls below the position of the lower filling level indicator 25, a valve 113 in the supply line 112 is opened and the water tank 11 is filled on account of the pressure prevailing in the water supply 110. When the water reaches the upper filling level indicator 25, the valve 113 is closed.

A removal system (not shown) allows for removal of water from the water tank 11 or any other liquid present in the water tank 11. For this purpose, the removal system comprises at least one pump. Removal systems of this type are used, for example, for cuspidors disposed directly next to the dentist's chair.

A suction system 4 is used in the vicinity of a rinsing unit 1 of this type. During dental treatment, liquids and solids are sucked from the patient's mouth with the aid of the suction system 4. The suction system 4 comprises a reduced pressure generator 41 and a suction handpiece 42, which is connected via a suction hose 43 and is used to remove the liquids and solids. The solids preferentially settle on the inside wall of the flexible suction hose 43.

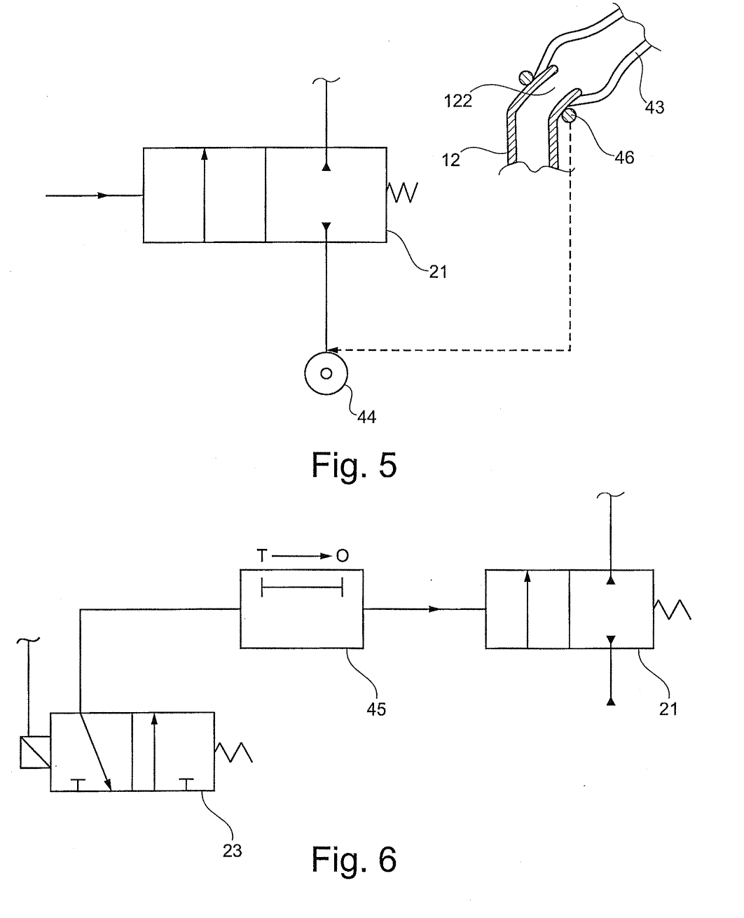

The suction hose 43 is cleaned with the aid of a cleaning tank 12 and a control unit 2. The cleaning tank 12 forms a reservoir 125 for the water and comprises an inlet orifice 120, by means of which the cleaning tank 12 is connected to the water tank 11 via a pipe 111. Furthermore, the cleaning tank 12 comprises a vent hole 121 and an outlet 122, as shown in FIG. 4. The vent hole 121 serves to vent the reservoir 125, when water is removed via the outlet 122. The outlet 122 is disposed at the end of a riser 126 connected to the reservoir 125 so that the vent hole 121 and the outlet 122 are separated by a water column.

A reduced pressure is generated in the cleaning tank 12 by means of the suction system 4 or the suction handpiece 42, which can be fitted to the outlet 122 of the cleaning tank 12 designed as a tap 124. If the vent hole 121 is in its closed position, water will be sucked from the water tank 11 into the cleaning tank 12 via the pipe 111, and the cleaning tank 12 is filled.

When a defined water level in the cleaning tank 12 is reached, the vent hole 121 is opened so that the water present in the cleaning tank 12 is sucked impulsively into the suction hose 43 due to the reduced pressure. This pulsed rinsing causes the water to pass at a high rate of flow through the suction hose 43, thereby entraining the settled solid particles to achieve a thorough cleaning effect.

The cleaning effect caused by dynamic flow is further improved due to the fact that the entire inside wall of the suction hose 43 is wetted by the water flowing therethrough, the latter having an appropriately large volume of water in the range of from 20 ml to 150 ml in the cleaning tank 12 or the reservoir 125.

One of the most significant features of the invention, namely that the volume of water for the pulsed rinsing of the suction system 4 is sucked from the water tank 11 by the suction system 4 itself necessitates a special design of the cleaning tank 12. The cleaning tank 12 must be constructed in such a way that water does not enter into the suction system 4 during the filling operation. For this purpose, the outlet 122 must be disposed in the upper region of the volume of the cleaning tank 12.

Furthermore, it must be ensured that after the vent hole 121 has been opened, the entire volume of water in the cleaning tank 12 flows into the suction system 4 without the inclusion of air. For this purpose, the vent hole 121 15 must be disposed in the upper region of the volume of the cleaning tank 12.

Moreover, the outlet 122 and the vent hole 121 must be separated by water or a water column. The air sucked through the vent hole 121 when the water is being sucked in must not enter the suction system as long as water is present in the cleaning tank 12.

These requirements can be met, for example, by configuring the cleaning tank 12 in the form of a U-shaped tube or a siphon. One possible solution is the cleaning tank 12 (shown in detail in FIG. 4) comprising the reservoir 125 and the riser 126 connected in the lower region of the reservoir 125 by means of a connection 123.

The inlet orifice 120 is disposed at any desired location between the vent hole 121 and the outlet 122. A valve 21 is connected to the vent hole 121, and the valve 21 is controlled by a control valve 23 and a control system 22 via control lines 220. The control valve 23 is an actuator that is intended for the valve 21 and is driven pneumatically by means of a compressed-air connection 212. The valve 21, control valve 23, and the control system 22 are parts of the control unit 2 for the rinsing unit 1.

The valve 21 is connected to the cleaning tank 12 by a vent pipe 210 and ensures, in its closed state, that the cleaning tank 12 fills up when the suction hose 43 is connected to the outlet 122. When the cleaning tank 12 has been filled with water, pulsed rinsing is initiated by opening the valve 21. To this end, the valve 21 is opened quickly and is dimensioned such that it throttles the suction air to the least possible extent in order to achieve a maximum flow rate of the water column in the U-shaped cleaning tank 12.

Such pulsed rinsing can be intensified by applying overpressure instead of atmospheric pressure to the valve 21 on the side facing the vent pipe 210. In this exemplary embodiment shown in FIG. 5, compressed air is conveyed, after the valve 21 has been opened, from a pressure vessel or a compressed-air connection 44 by way of the valve 21 and the vent pipe 210 into the reservoir 125. The compressed air further intensifies the pulse generated by the reduced pressure already prevailing in the cleaning tank 12 before the valve was opened. A sensor 46 is provided, which detects whether the suction hose 43 is connected to the outlet 122 of the cleaning tank 12 and switches off the overpressure immediately when there is premature removal of the suction hose.

The rinsing units 1 shown in FIG. 1 to FIG. 3 differ from one another with regard to the regulating and control means by means of which the rinsing operation is initiated and carried out.

According to the method illustrated in FIG. 1, the valve is in a closed position in the quiescent state before the rinsing operation starts. When the suction hose 43 is connected to the cleaning tank 12, a reduced pressure is generated in the cleaning tank 12 and the process of filling the cleaning tank 12 is initiated. A pressure sensor 24, which is activated by the pressure drop in the cleaning tank 12 and in the vent pipe 210 on connection of the suction hose 43 to the cleaning tank 12 and transmits an appropriate signal to the control system 22 of the control unit 2, is connected to the vent pipe 210.

A timer 45 controls the duration of the filling operation. In FIG. 1, the timer 45 is integrated in the control system 22. In FIG. 6, the timer 45 is shown as a pneumatic unit situated between the control valve 23 and the valve 21. The timer 45 delays the signal of the control valve 23 to the valve 21 by a corresponding time interval. On expiration of this time interval following the point of activation of the pressure sensor 24, the valve 21 is kept open, thereby allowing pulsed rinsing to take place. This process is repeated as long as the suction hose 43 is connected to the cleaning tank 12, that is to say, the valve 21 is reclosed and the process is repeated. Alternatively, the control system 22 interrupts the rinsing operation after one or more pulsed rinsing operations as long as the suction hose 43 is not removed from the tap 124. Upon removal of the suction hose 43, the reduced pressure is no longer present and the pressure sensor 24 is no longer activated. The valve 21 thus remains in the closed state and the rinsing unit 1 is in the quiescent state.

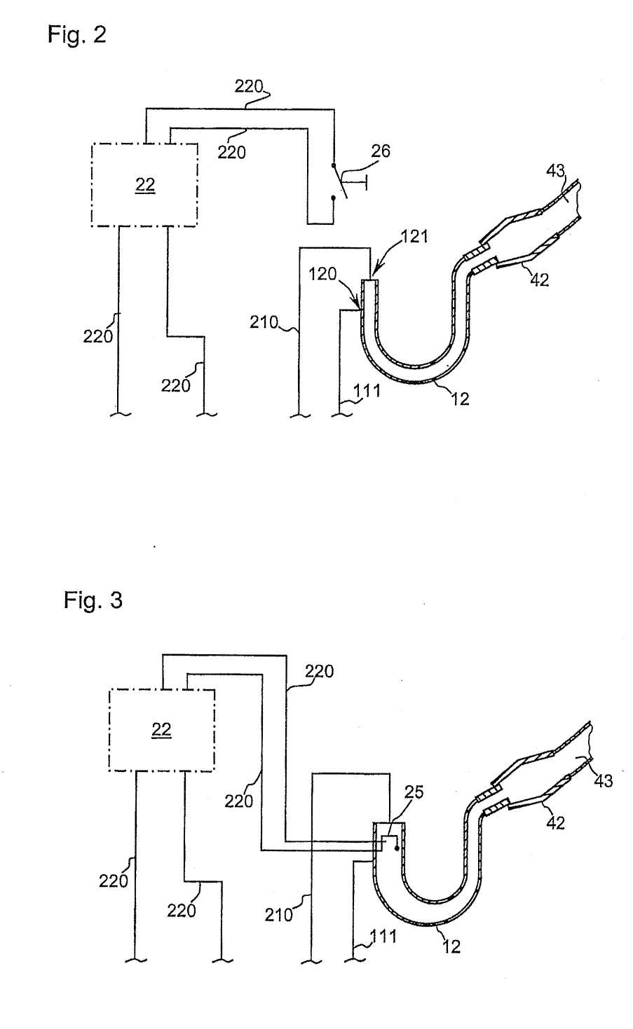

In an exemplary embodiment according to FIG. 2, a manual switch 26 is provided instead of the pressure sensor 24. By means of the manual switch 26, a signal can be generated which causes closure of the valve 21, and thereby initiates the aforementioned rinsing operation once or a number of times. In this exemplary embodiment, the valve 21 is in its open position in the quiescent state.

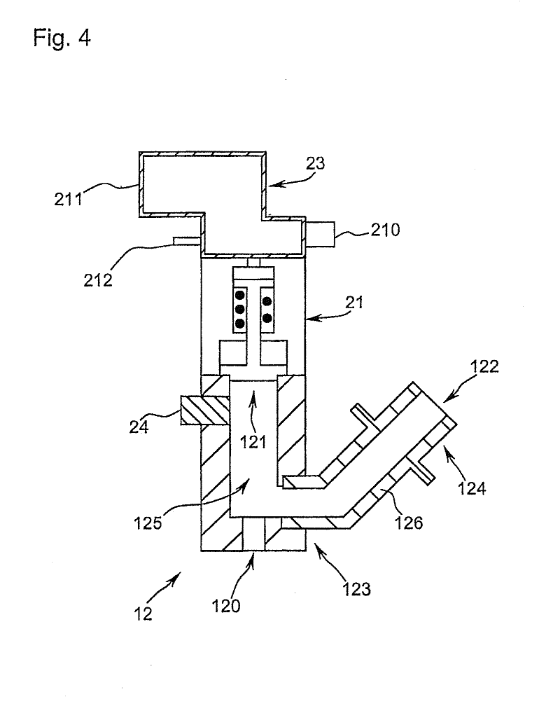

In another exemplary embodiment shown in FIG. 3, a filling level indicator 25 is provided in the cleaning tank 12 instead of the timer 45. By means of the filling level indicator 25, a signal is generated when a defined water level has been reached, and this signal causes the valve 21 to open. The valve 21 is in its closed position in the quiescent state before the start of the rinsing operation.

The method variant involving the filling level indicator 25 shown in FIG. 3 is provided in combination with the pressure sensor 24. This method may also be combined with the manual switch 26 in accordance with the method illustrated in FIG. 2. The rinsing operation is thus initiated whenever the suction hose 43 is connected to the cleaning tank 12 and this state is indicated to the control system 22 with the aid of the pressure sensor 24 or the switch 26.

The pressure sensor 24, the switch 26, and the filling level indicator 25 are connected to the control system 22 via control lines 220.

As shown in FIG. 1, a mixing unit 3 is provided, with the aid of which a predetermined quantity of cleaning agent or disinfectant can be added to the water in the water tank 11 during the filling operation.

FIG. 4 shows an exemplary embodiment of the cleaning tank 12, including the inlet orifice 120, the vent hole 121, and the outlet 122 and meets the requirements of the described shape of a siphon. The cleaning tank 12 itself comprises the cylindrical reservoir 125 for the water and the riser 126, which forms the outlet 122 and extends substantially vertically and is connected to the reservoir 125. The riser 126 is connected via the connection 123 to the reservoir 125 compatible with fluid engineering requirements. The riser 126 is connected to the base of the reservoir 125 and extends upwardly via an angled pipe. Air cannot escape from the vent hole 121 through the riser 126 and outlet 122 before the reservoir 125 is at least almost completely empty.

The inlet orifice 120 is disposed on the base of the cleaning tank 12 or the reservoir 125 and the pipe (not shown) leading from the water tank 11 is connected to the inlet orifice 120. The valve 21 is disposed in a valve housing 211, which sits on the cleaning tank 12. The compressed-air connection 212 from a compressed-air source 213 for activating the control valve 23 is disposed on the valve housing 211.

The reservoir 125 is closed at the top by the valve housing 211. Thus, no other openings are provided on the cleaning tank 12 apart from the inlet orifice 120, the vent hole 121, and the outlet 122.

1. A dental rinsing unit having at least one water tank, and having a cleaning tank for cleaning a suction hose equipped with a suction handpiece for sucking liquids and solids from a patient's mouth, which cleaning tank has an inlet orifice that communicates with said water tank, and which furthermore has an outlet for the attachment of said suction hose, and said outlet is in the form of a tap for said suction handpiece mounted on said suction hose, wherein said cleaning tank has at least one first sub-container in the form of a reservoir for holding water and a second sub-container in the form of a riser communicating with said reservoir, whilst the open end of said riser remote from said reservoir forms said outlet, and connecting means between said reservoir and said riser is disposed below a vent hole of said cleaning tank and below said outlet.

2. The rinsing unit as defined in claim 1, wherein said cleaning tank can be filled with water from said water tank by means of reduced pressure applied when said suction hose is connected to said outlet.

3. The rinsing unit as defined in claim 2, wherein said cleaning tank has, in addition to said inlet orifice, a vent hole and that at least one valve is situated on said vent hole, and said valve can be opened, closed and adjusted manually and/or automatically with the aid of a control system in a control unit in accordance with at least one physical parameter.

4. The rinsing unit as defined in claim 3, wherein said control unit additionally has a control valve for actuating said valve.

5. The rinsing unit as defined in claim 3, wherein said control unit cooperates with at least one pressure sensor, which is adapted to detect the reduced pressure within said water tank and/or said cleaning tank for control engineering purposes.

6. The rinsing unit as defined in claim 5, wherein said control unit has at least one filling level indicator disposed in said cleaning tank, by means of which at least one water level in said cleaning tank can be detected for control engineering purposes.

7. The rinsing unit as defined in claim 2, wherein said control unit has at least one manually operable switch, by means of which said valve can be switched.

8. The rinsing unit as defined in claim 2, wherein the output of said valve communicates with said vent hole and that said input valve communicates with the atmosphere or with a pressure tank.

9. The rinsing unit as defined in claim 8, wherein a sensor is provided which detects docking of said suction hose in said outlet of said cleaning tank and immediately switches off the overpressure when said suction hose is prematurely removed.

10. The rinsing unit as defined in claim 1, wherein said cleaning tank is disposed relatively to said water tank above the highest possible filling level of the water in said water tank.

11. The rinsing unit as defined in claim 1, wherein a mixing unit is connected to said water tank for the metered supply of a cleaning agent.

12. The rinsing unit as defined in claim 1, wherein said reservoir and said riser are in the form of a U-shaped pipe or tubing or in the form of a siphon.

13. A system consisting of a rinsing unit as defined in claim 1 and a dental suction apparatus, wherein the suction apparatus has at least one suction handpiece connected via a suction hose.

14. The system as defined in claim 13, wherein said suction apparatus has a plurality of suction hoses and said rinsing unit a plurality of cleaning tanks and/or a plurality of taps on a cleaning tank.

15. A method for cleaning a suction hose of a suction handpiece dental suction apparatus including a rinsing unit the method comprising:
a) at least partially filling a water tank with water;
b) switching on said suction apparatus;
c) connecting said suction hose to an outlet of a cleaning tank, which outlet (122) is in the form of a tap;
d) closing a vent hole of said cleaning tank;
and then the following:
e) a reduced pressure produced in said cleaning tank by said suction apparatus via said suction hose sucking water from said water tank into said cleaning tank;
f) controlling an amount of water flowing into said cleaning tank by time measurement or with the aid of a level indicator in said cleaning tank;
g) after a certain amount of water has flowed into said cleaning tank, opening a valve and sucking in a volume of water present in said cleaning tank by said suction apparatus so the water leaves said cleaning tank at least partially impulsively and flows through said suction hose from its free end.

16. The method as defined in claim 15, wherein the time measurement for opening said valve is initiated by a timing circuit in the control system when said valve is closed.

17. The method as defined in claim 15, wherein said valve is opened when said filling level indicator in said cleaning tank signals that the maximum filling level has been reached.

18. The method as defined in claim 15, wherein said valve is closed as soon as the rinsing operation is over or a reduced pressure is generated in said cleaning tank.

19. The method as defined in claim 15, wherein said valve is closed by the manually operable switch in the control system prior to the filling of said cleaning tank.

20. The method as defined in claim 15, wherein on conclusion of a first rinse and before said suction hose is removed from said outlet at least one further rinse is carried out.

21. The method as defined in claim 15, wherein when said valve is opened, water in the cleaning tank is fed to said suction hose not only by the reduced pressure produced at said outlet but also by means of compressed air, said compressed air being introduced via said valve.
